(19) United States
(12) Patent Application Publication
(10) Pub. No.: US 2021/0358190 A1
(43) Pub. Date: Nov. 18, 2021

(54) METHOD OF GENERATING ITEM FOR AVATAR, RECORDING MEDIUM AND COMPUTING DEVICE

(71) Applicant: LINE Plus Corporation, Seongnam-si (KR)

(72) Inventors: Yei Won CHOI, Seongnam-si (KR); Yun Ji LEE, Seongnam-si (KR)

(73) Assignee: LINE Plus Corporation, Seongnam-si (KR)

(21) Appl. No.: 17/308,231

(22) Filed: May 5, 2021

(30) Foreign Application Priority Data
May 12, 2020 (KR) 10-2020-0056318

(51) Int. Cl. G06T 13/40; G06T 19/20; G06T 17/20

(52) U.S. Cl. CPC G06T 13/40; G06T 2219/2024; G06T 17/20; G06T 19/20

(57) ABSTRACT

Methods of generating item for an avatar, recording mediums having recorded thereon a program that when executed by a processor, causes a computing device to execute such methods, and computing devices for implementing such methods may be provided. The method including extracting a target item selected by a user device from an image, classifying the extracted target item into a category, providing a template of the target item in association with the category, obtaining a style attribute of the extracted target item from the image, and generating a virtual item to be applied to the avatar based on a template, the modified template created by adding the obtained style attribute to the template.

### CROSS REFERENCE TO RELATED APPLICATION

The present application claims priority to Korean Patent Application No. 10-2020-0056318 filed on May 12, 2020, the entire contents of which are incorporated herein for all purposes by this reference.

### BACKGROUND

### Field

The present disclosure relates to methods of generating item for an avatar, recording mediums and/or computing devices, and, more particularly, to methods of generating an item for an avatar, which is capable of automatically generating a virtual item to be applied to an avatar from an item obtained from an image, recording mediums having recorded thereon a program that when executed by a processor, causes a computing device to execute such methods, and/or computing devices for implementing such methods.

### Description of the Related Art

An avatar is a visual image of a user used in cyberspace and means a virtual graphic character representing the user in community sites, instant messengers, shopping malls, online games or the like.

The avatar may be expressed through a body configuring the avatar and may be expressed using various virtual items worn on or possessed by the avatar, as a means for expressing individuality of the avatar online. The virtual items may include, for example, clothes, accessories and belongings.

Conventional virtual items are provided in a state of being already generated in an application in which the avatar is used. However, a provider of an avatar service cannot generate virtual items for an avatar for each of a large amount of items present in real time and thus a user cannot obtain a virtual item having the same shape as an actual item recognized in the surroundings, in addition to the generated virtual items.

In order to emphasize the individuality of the avatar or secure various designs of the item for the avatar, there is a need for a method of automatically or easily generating the item for avatar using an actual item desired by a user.

### SUMMARY

Accordingly, the present disclosure has been made keeping in mind the above problems occurring in the prior art.

At least one example embodiment of the present disclosure provides a method of generating an item for an avatar, which is capable of automatically or easily generating a virtual item to be applied to an avatar from an item obtained from an image.

At least one example embodiment of the present disclosure provides a computer-readable recording medium having recorded thereon a program that when executed by a processor, causes the method of generating the item for the avatar to be executed on a computing device.

At least one example embodiment of the present disclosure provides a computing device for implementing the method of generating the item for the avatar.

According to an example embodiment of the present disclosure, a method of generating an item for an avatar performed by a computing device including at least one processor includes extracting a target item selected by a user device from an image, classifying the extracted target item into a category, providing a template of the target item in association with the category, obtaining a style attribute of the extracted target item from the image, and generating a virtual item to be applied to the avatar based on a modified template, the modified template created by adding the obtained style attribute to the template.

According to an example embodiment of the present disclosure, the classifying may include classifying the target item into a first category, and classifying the target item into a secondary category, the second category being a subcategory of the first category, and the providing may include providing a specific template associated with the second category as the template of the target item.

According to an example embodiment of the present disclosure, the providing may include providing, as the template of the target item, a specific template having a highest degree of similarity with at least one of an overall contour shape and a feature element of the extracted target item among templates in the category.

According to an example embodiment of the present disclosure, the style attribute may be a design element related to a portion of the target item in addition to an overall contour shape of the extracted target item.

According to an example embodiment of the present disclosure, the obtaining may include obtaining the style attribute from the image based on at least one of an entire or partial shape of the avatar, an entire or partial shape of the template, or a characteristic degree of the style attribute in the image.

According to an example embodiment of the present disclosure, the generating may include converting an image of the obtained style attribute into a virtual style image to have a same format as an image format of the avatar, synthesizing the virtual style image with a three-dimensional mesh of the template to approximate arrangement of the style attribute of the image, modifying the template in which the virtual style image is synthesized, and providing the modified template to the avatar.

According to an example embodiment of the present disclosure, the method further may include generating a change request for the style attribute in the virtual item in the user device, and generating a changed virtual item based on a changed template, the changed template being the template of the target item in which the style attribute has been changed according to the change request.

According to an example embodiment of the present disclosure, the generating the change request may include in case of deleting the style attribute from the virtual item, detecting a first designation of the style attribute of a deletion region, receiving a deletion instruction among presented options of a change menu and generating the change request, in case of adding an additional style attribute which is not present in the virtual item, detecting a second designation of a specific portion of the virtual item of an addition region, receiving an addition instruction among the presented options of the change menu, presenting a target item image including the target item according to the addition instruction, receiving a request for adding the additional style attribute in the image corresponding to the designated specific portion of the virtual item, and generating the change request, and in case of replacing the style attribute in the virtual item with a selected candidate style attribute, detecting a third designation of the style attribute of a replacement region, receiving a replacement instruction among the presented options of the change menu, presenting candidate style attributes different from the style attribute to be replaced, receiving a replacement request according to the selected candidate style attribute and generating the change request.

According to an example embodiment of the present disclosure, the generating the change request may include activating an editing tool for changing the style attribute, and generating the change request including at least one of addition, deletion or replacement of the style attribute with respect to at least a portion of the virtual item, based on manipulation of the editing tool from the user device.

According to an example embodiment of the present disclosure, the method may further include uploading the virtual item by the user device, receiving selection of the virtual item from another user device, receiving an input of another style attribute from the another user device, the another style attribute being different from that of the virtual item, and generating a renewed virtual item based on the received style attribute.

According to an example embodiment of the present disclosure, a computing device includes at least one processor configured to execute computer-readable instructions included in a memory such that the processor is configured to cause the computing device to extract a target item selected by a user device from an image, classify the extracted target item into a category, provide a template of the target item in association with the category, obtain a style attribute of the extracted target item from the image, and generate a virtual item to be applied to an avatar based on a modified template, the modified template created by adding the obtained style attribute to the template.

According to an example embodiment of the present disclosure, the processor may be configured to cause the computing device to classify the extracted target item by classifying the target item into a first category, and classifying the target item into a secondary category, is the second category being a subcategory of the first category, and the processor may be configured to cause the computing device to provide a specific template associated with the second category as the template of the target item.

According to an example embodiment of the present disclosure, the processor may be configured to cause the computing device to provide, as the template of the target item, a template having a highest degree of similarity with at least one of an overall contour shape and a feature element of the extracted target item among templates in the category.

According to an example embodiment of the present disclosure, the style attribute may be a design element related to a portion of the target item in addition to an overall contour shape of the extracted target item.

According to an example embodiment of the present disclosure, the processor may be configured to cause the computing device to obtain the style attribute from the image by obtaining the style attribute from the image based on at least one of an entire or partial shape of the avatar, an entire or partial shape of the template, or a characteristic degree of the style attribute in the image.

According to an example embodiment of the present disclosure, the processor may be configured to cause the computing device to generate the virtual item by converting an image of the obtained style attribute into a virtual style image to have a same format as an image format of the avatar, synthesizing the virtual style image with a three-dimensional mesh of the template to approximate arrangement of the style attribute of the image, modifying the template in which the virtual style image is synthesized, and providing the modified template to the avatar.

According to an example embodiment of the present disclosure, the processor may be further configured to cause the computing device to generate a change request of the style attribute for the virtual item in the user device, and generate a changed virtual item based on a changed template, the changed template being the template of the target item in which the style attribute has been changed according to the change request.

According to an example embodiment of the present disclosure, the processor may be configured to cause the computing device to generate the change request by in case of deleting the style attribute from the virtual item, detecting a first designation of the style attribute of a deletion region, receiving a deletion instruction among presented options of a change menu and generating the change request, in case of adding an additional style attribute which is not present in the virtual item, detecting a second designation of a specific portion of the virtual item of an addition region, receiving an addition instruction among the presented options of the change menu, presenting a target item image including the target item according to the addition instruction, receiving a request for adding the additional style attribute in the image corresponding to the designated specific portion of the virtual item, and generating the change request, and in case of replacing the style attribute in the virtual item with a selected candidate style attribute, detecting a third designation of the style attribute of a replacement region, receiving a replacement instruction among the presented options of the change menu, presenting candidate style attributes different from the style attribute to be replaced, receiving a replacement request according to the selected candidate style attribute and generating the change request.

According to an example embodiment of the present disclosure, the processor may be configured to cause the computing device to generate the change request by activating an editing tool for changing the style attribute, and generating the change request including at least one of addition, deletion or replacement of the style attribute with respect to at least a portion of the virtual item, based on manipulation of the editing tool from the user device.

According to an example embodiment of the present disclosure, there is provided a computer-readable recording medium having recorded thereon a computer program that when executed by at least one processor, causes a computing device to implement the method of generating item for avatar.

The features briefly summarized above for this disclosure are only example aspects of the detailed description of the disclosure which follow, and are not intended to limit the scope of the disclosure.

The technical problems solved by the present disclosure are not limited to the above technical problems and other technical problems which are not described herein will be clearly understood by a person (hereinafter referred to as an ordinary technician) having ordinary skill in the technical field, to which the present disclosure belongs, from the following description.

### BRIEF DESCRIPTION OF THE DRAWINGS

FIG. 1 is a view illustrating a system in which a method of generating an item for an avatar according to an example embodiment of the present disclosure may be performed.

FIGS. 2A and 2B are block diagrams illustrating a user device and a server for performing a method of generating an item for an avatar according to an example embodiment of the present disclosure.

FIG. 3 is a flowchart illustrating a method of generating an item for an avatar according to an example embodiment of the present disclosure.

FIG. 4 is a view illustrating an example of an initial screen for generating an item for an avatar according to an example embodiment of the present disclosure.

FIG. 5 is a view illustrating an example of selecting a target item from an image according to an example embodiment of the present disclosure.

FIG. 6 is a view illustrating an example of a process of generating a virtual item according to an example embodiment of the present disclosure.

FIG. 7 is a view showing an example of presenting a virtual item according to an example embodiment of the present disclosure.

FIG. 8 is a view illustrating an example of an avatar, to which a virtual item is finally applied, according to an example embodiment of the present disclosure.

FIG. 9 is a flowchart illustrating a method of generating an item for an avatar according to another example embodiment of the present disclosure.

FIG. 10 is a view illustrating an example of changing a style attribute in a virtual item according to another example embodiment of the present disclosure.

FIG. 11 is a view illustrating an example of additionally changing a style attribute of an image of an item according to another example embodiment of the present disclosure.

FIG. 12 is a view illustrating an example of a generated virtual item according to another example embodiment of the present disclosure.

FIG. 13 is a view illustrating an example of an avatar, to which a changed virtual item is finally applied, according to another example embodiment of the present disclosure.

FIG. 14 is a flowchart illustrating a method of generating an item for an avatar according to another example embodiment of the present disclosure.

FIGS. 15 to 17 are views illustrating an example of changing a style attribute in a virtual item using an editing tool according to an example embodiment of the present disclosure.

FIG. 18 is a flowchart illustrating a method of generating an item for an avatar according to another example embodiment of the present disclosure.

FIG. 19 is a view illustrating an example of inputting a style attribute from a second user device for a shared virtual item according to another example embodiment of the present disclosure.

### DESCRIPTION

Hereinafter, some example embodiments of the present disclosure will be described in detail with reference to the accompanying drawings to the extent that the present disclosure can be easily carried out by those skilled in the art. However, the present disclosure may be embodied in various forms and should not be construed as being limited to the example embodiments described herein.

In describing the example embodiments, well-known functions or constructions will not be described in detail when it is determined that they may obscure the spirit of the present disclosure. Further, components not associated with the present disclosure are not shown in the drawings and like reference numerals are given to like components.

It is to be understood in the following description that when one component is referred to as being “connected to”, “combined with”, or “coupled to” another component, the expression may include not only direct connection but also indirect connection between the components. It will be further understood that when a component “comprises” or “has” another component, it means that the component may further include another component, not excluding another component unless stated otherwise.

It will be understood that, although the terms “first”, “second”, etc. may be used herein to describe various components, these components should not be limited by these terms. These terms are only used to distinguish one component from another component. Accordingly, within the description of the present disclosure, a first component in one example embodiment may be referred to as a second component in another example embodiment, and likewise a second component in one example embodiment may be referred to as a first component in another example embodiment.

As used herein, the term “and/or” includes any and all combinations of one or more of the associated listed items. Expressions such as “at least one of,” when preceding a list of elements, modify the entire list of elements and do not modify the individual elements of the list. Thus, for example, both “at least one of A, B, or C” and “A, B, and/or C” means either A, B, C or any combination thereof.

In the following description, components are discriminated from each other to clearly describe their characteristics, but it does not mean that they are necessarily physically separated. That is, a plurality of components may be integrated in one hardware or software module and one component may be divided into a plurality of hardware or software modules. Accordingly, an integrated form of different components or divided forms of one component fall within the scope of the present disclosure even though not specifically stated.

In the following description, components described in various example embodiments may not be all necessarily required but some components may be optional. Accordingly, an example embodiment composed of a subset of the components included in an arbitrary example embodiment also falls within the scope of the present disclosure. Further, an example embodiment resulting from adding at least one component to a certain example embodiment described above also falls within the scope of the present disclosure.

In addition, in this specification, the term “network” is a concept including both cable networks and wireless networks. The network refers to a communication network through which data can be exchanged between a device and a system or between devices and is not limited to a specific network.

In the present specification, the device may be a stationary device such as a home appliance equipped with a personal computer (PC) function or a display function or may be a mobile device such as a smartphone, a tablet PC, a wearable device, and a head mounted display (HMD) device. Alternatively, the device may be a computing device, a vehicle, or an Internet of Things (IoT) device each of which is operable as a server. That is, in the present specification, the device refers to any kind of device capable of performing a composition image creation method of the present invention and is not limited to a specific type.

Hereinafter, some example embodiments of the present disclosure will be described with reference to the accompanying drawings.

FIG. 1 is a view illustrating a system in which a method of generating an item for an avatar according to an example embodiment of the present disclosure may be performed.

The system according to an example embodiment of the present disclosure may include one or more user devices 101, 102 and 103 and a server 110 connected over a network 104.

Each of the user devices 101, 102 and 103 may be referred to as a client or a user terminal and may access the server 110 over the network 104 to transmit and receive data to and from other user devices or the server.

The method of generating the item for the avatar according to an example embodiment of the present disclosure may be performed using an avatar service provided in connection with various online services. The online services may include portal sites, instant messengers, social media, community sites, online games, shopping malls, or the like. The avatar service provides a tool for representing a user as a virtual character in an online service. A client module for using the avatar service may be installed in each of the user devices 101, 102 and 103. Further, a server module for supporting the avatar service may be installed in the server 110. In the present disclosure, an avatar application installed in the user device may mean a client module installed in each of the user devices 101, 102 and 103 in order to use the avatar service.

The server 110 may provide a service such as an avatar application. The user who wishes to use the service may input a desired (or alternatively, predetermined) access information (an ID and a password) through a user device to access the server 110 for providing the service. The server 110 may identify the user, who has accessed the server, through the access information received from the user device. Further, the server 110 may collect, accumulate, store and query information on the identified users or support data transmission and reception between the identified users.

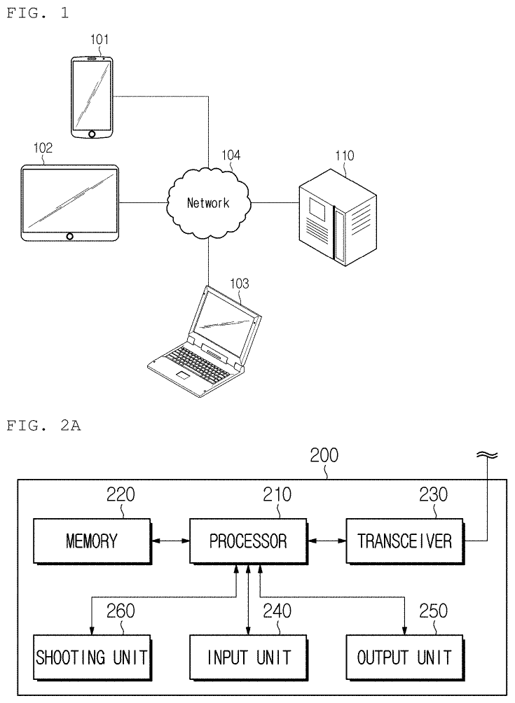

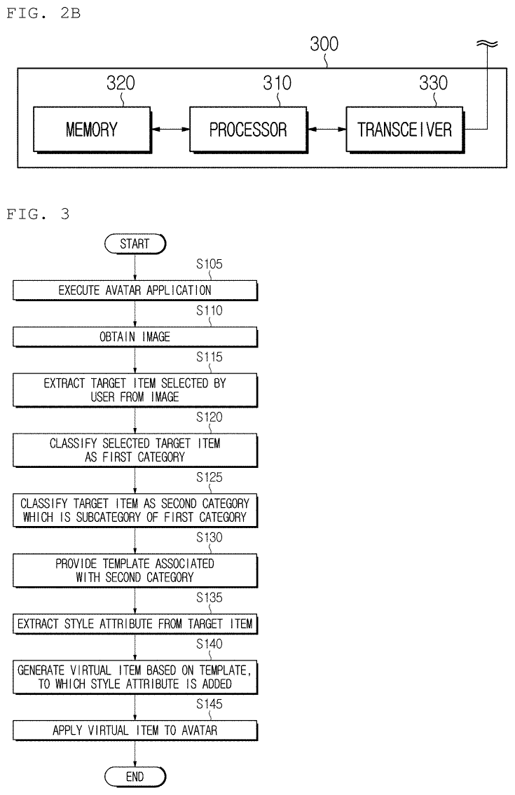

FIGS. 2A and 2B are block diagrams illustrating a user device and a server for performing a method of generating an item for an avatar according to an example embodiment of the present disclosure.

Referring to FIG. 2A, a user device 200 may include a processor 210, a memory 220, a transceiver 230, an input unit 240, an output unit 250 and a shooting unit 260. The user device 200 may further include other components related to operation and function of the device, without being limited to the above-described example embodiment.

The processor 210 may control operation of the other components in the user device 200. For example, the processor 210 may process information obtained through the input unit 240 and the transceiver 230. Further, the processor 210 may read and process information stored in the memory 220. The processor 210 may output the processed information through the output unit 250, store the processed information in the memory 220 or transmit the processed information to the outside through the transceiver 230.

For example, the processor 210 may receive all information on generation of the item for the avatar, such as an image obtained as a target item and style attribute change/input request in the item for the avatar, through the transceiver 230 or the input unit 240 or read the information from the memory 220. Further, the processor 210 may process the information on generation of the item for the avatar and then store the processed information in the memory 220, transmit the processed information to the outside through the transceiver 230 or output the processed information through the output unit 250.

The memory 220 may store information obtained from the outside of the user device 200, such as information received from another user device through the transceiver 230 or information obtained through the input unit 240 of the user device. Further, the memory 220 may store information generated inside the user device 200. For example, information generated by performing the method of generating the item for the avatar according to the present disclosure may be stored in the memory 220. For example, the memory 220 may include a database.

The transceiver 230 may exchange data with the server 110 or another user device over the network 104. The transceiver 230 may include all types of wired/wireless communication modules capable of performing communication with the outside.

The input unit 240 may include input devices implemented as various sensors or mechanical buttons provided in the user device 200. The user device 200 may include, for example, an input device using a pressure detection sensor or a static touch sensor (e.g., a virtual keyboard displayed on a touchscreen), a mechanical button or the like as the input unit 240. The user device 200 may obtain information detected by the sensor or input of the mechanical button as input information.

The output unit 250 may output information obtained or received by the user device 200, information processed by the user device 200 or the like to the outside. The output unit 250 may include, for example, a display for outputting visual information.

The shooting unit 260 may include all types of shooting devices capable of obtaining a still image or a moving image. For example, the shooting unit may be a camera module provided in a smartphone.

Referring to FIG. 2B, a server 300 may include a processor 310, a memory 320 and a transceiver 330. The server 300 may further include other components related to operation of the server or the system, without being limited to the above-described example embodiment.

The processor 310 may control operation of the other components in the server 300. For example, the processor 310 may process information obtained through the transceiver 330. Further, the processor 310 may read and process information stored in the memory 320. The processor 310 may store the processed information in the memory 320 or transmit the processed information to the outside through the transceiver 330.

For example, the processor 310 may receive all information on generation of the item for the avatar, such as an image obtained as an actual item or style attribute change/input request in the item for the avatar through the transceiver 330 or read the information from the memory 320. Further, the processor 310 may process the received image, perform a virtual item generation process according to a request, and store the processed information in the memory 320 or transmit the processed information to the outside through the transceiver 330.

The memory 320 may store information received from the outside through the transceiver 330. Further, the memory 320 may store information generated inside the server 300. For example, information generated by performing the method of generating the item for the avatar according to the present disclosure may be stored in the memory 320. For example, the memory 320 may include a database.

The transceiver 330 may exchange data with a user device or another server connected over a network 104. The transceiver 330 may include all types of wired/wireless communication modules capable of performing communication with the outside.

The user device and/or the server according to an example embodiment of the present disclosure may be an example of a computing apparatus or a computing device.

FIG. 3 is a flowchart illustrating a method of generating an item for an avatar according to an example embodiment of the present disclosure.

In the present disclosure, an avatar is a virtual character representing the characteristics of a user in the form of graphics or animation, and may be represented in various forms such as people, animals, personified animals or things. A virtual item is an object that decorates the body of the avatar and may be processed in the same format as the image format of the avatar. The avatar and the virtual item may be generated in a two-dimensional or three-dimensional form. The virtual item may include, for example, clothes such as coats, dresses or hats or accessories such as necklaces, glasses, hairpins, brooches or rings that may be worn on the avatar or belongings such as bags, umbrellas, or cups that may be possessed by or placed around the avatar.

The method of generating the item for the avatar according to the example embodiment of the present disclosure may generate a virtual item in the server 300 for the image of the actual item received from the user device 200.

First, the user device 200 executes an avatar application to display an initial screen on the output unit 250 (S105).

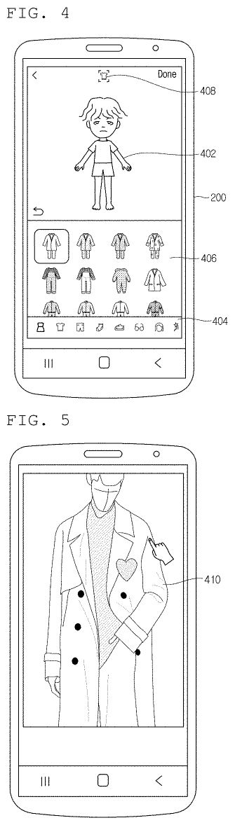

FIG. 4 is a view illustrating an example of an initial screen for generating an item for an avatar according to an example embodiment of the present disclosure.

The user may enter the initial screen of the avatar application displayed on the output unit 250 through an online service linked to the application or an avatar-only application.

The initial screen may include an avatar 402 representing the virtual character of the user, a menu 404 showing a list of higher categories of a virtual item selectable by the user, an item selection region 406 belonging to a category selected by the user in the menu 404 and showing existing virtual items which have already been generated, and a generation button 408 for generating an item using the user device 200.

When the user first generates the avatar 402 and applies an item, the avatar 402 may be provided in the initial form of the avatar selected or generated by the user. As another example, the avatar 402 may be provided in the form of a virtual item which has been selected by the user.

The menu 404 may show higher categories of an item previously set in the avatar application and the higher categories may be simply set to one level. Here, one level means an operation or a step of providing virtual items in the item selection region 406 after one of the higher categories is selected. As another example, the higher categories may be set to a plurality of levels and, when the user selects a highest category of a highest level, a next level of the highest categories may be displayed in a next process such that the user may select a next highest category corresponding to a next level. Therefore, after the user designates up to a lowest level, the item selection region 406 may be displayed. As another example, the higher categories configuring the menu 404 may be additionally generated for each user in addition to the preset (or alternatively, existing) higher categories, unlike the above description. According to the example embodiment of the present disclosure, when a virtual item is newly generated, the user may request additional generation of a higher type other than the preset (or alternatively, existing) higher types with respect to the new virtual item. When the server 300 determines that the type of the new virtual item does not correspond to the existing higher types, the server 300 may newly generate a higher type and include the new virtual item to the newly generated type. Therefore, another user may share the new virtual item. As another example, the higher type newly generated by the request of the user device 200 or the server 300 may not be displayed on the menu 404 of the user device 200 in which the new virtual item has been generated, according to the personalization instruction of the user device 200.

The item selection region 406 may include a plurality of existing virtual items for each higher type. The existing virtual items may be graphic or animated images which may be worn on, possessed by or placed around the avatar, as described above. When the new virtual item is generated and the higher type is determined by the user device 200, the new virtual item may be newly generated in connection with the higher type. The new virtual item may be generated in the item selection region 406 to be shared with other users or to be privately owned according to the request of the user device 200.

The generation button 408 activates a function for generating the virtual item based on the image of the item obtained by the user, upon receiving user input. Input reception may be detected by user touch input or a pointing device. The pointing device may be an auxiliary designation tool such as a mouse or a stylus pen.

Subsequently, when input for the generation button 408 is received, the user device 200 obtains an image by requesting the user to obtain an image for an item (S110).

Although not shown, the request for obtaining an image may be implemented by input through the shooting unit 260 or the memory 220 and capturing of an image posted on a web page. As another example, an image including a plurality of items may be obtained based on a user activity history such as item search or purchase performed through the user device 200 in an online service linked or unlinked with an avatar application.

Next, the user device 200 recognizes a target item in the image, which is selected by the user, and extract the selected target item (S115), after obtaining the image including the target image.

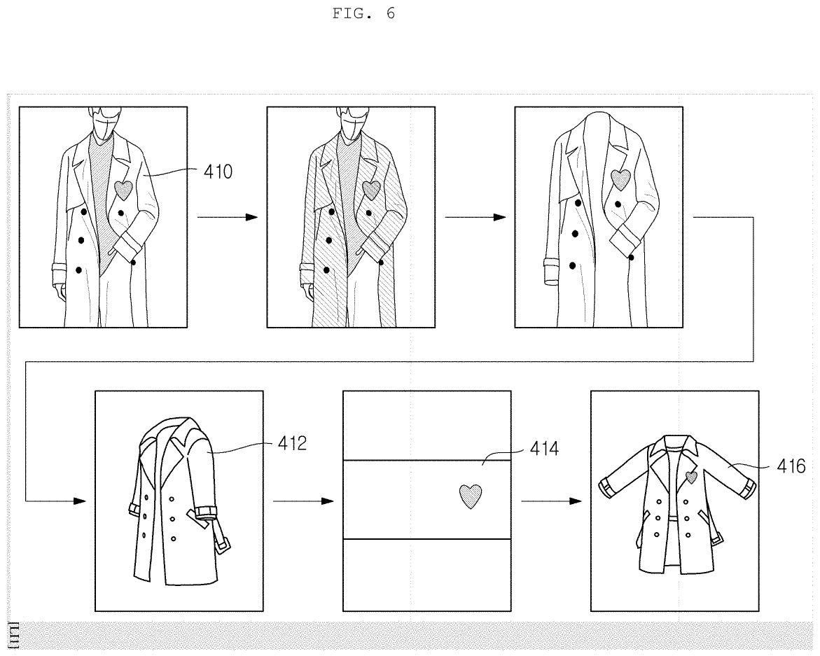

FIG. 5 is a view illustrating an example of selecting a target item from an image according to an example embodiment of the present disclosure.

The user device 200 displays an image including at least one actual item and extract a target item 410 designated by user selection from the image. For example, when a plurality of actual items is included in the image, the user device 200 partitions an region for each actual item to receive user selection. The user device 200 may detect objects related to the plurality of actual items by display pixel analysis using elements such as continuous border lines and color/texture/pattern change in the image, and partition and set the region for each actual item. Such division may be performed through the avatar application of the user device 200 or the obtained entire image may be transmitted to the server 300 and then an image in which the regions are set may be returned to the user device 200.

The user device 200 may recognize the target item 410 by user selection in the image in which the regions are partitioned for each actual item. User selection may be detected by user touch input or a pointing device. The user device 200 may provide the user with the highlighted region of the target item 410 recognized by the device, for example, a highlighted color for an entire target item or a highlighted outer contour of the target item 410, in order to confirm the selected target item 410. The user may approve the target item recognized by the user device 200 through highlighted display.

Thereafter, the approved target item 410 may be extracted.

As another example, the user device 200 may select at least one of objects related to the plurality of items based on a user activity history performed by the user of the user device 200 in an online service linked or non-associated with an avatar application. The user device 200 may also display the selected at least one object to be distinguished from the other objects. For example, when the user searches for a keyword “coat” more than a desired (or alternatively, predetermined) number of times through a search service recently (e.g., within one day) or when the user has purchased a coat recently (e.g., within one week) through a shopping service, the user device 200 may select and display a coat object from among the coat object, a t-shirt object and a pants object extracted from the image.

FIG. 6 is a view illustrating an example of a process of generating a virtual item according to an example embodiment of the present disclosure.

From the left of FIG. 6, a first figure shows a screen, on which the image of the actual item is displayed, in the user device 200, and the second and third figures of FIG. 6 show a process of extracting the approved target item 410 by the server 300.

The server 300 may cut and extract only the target item 410 selected by the user from the image. For cutting and extraction, an outermost contour of the target item 410 may be detected based on a region designated by the user and only the target item 410 may be cut and extracted along the outermost contour. As an example of cutting and extraction, an outermost contour may be detected by target masking and the target item may be extracted along the detected contour. As another example, the user device 200 may cut the target item 410 by the above-described extraction and transmit the image of the cut target item to the server 300.

Next, the server 300 classify the selected target item as a first category (S120).

The first category may be classified into major categories for each actual item and may be generated as major categories for classifying actual items derived from an image by group using a deep learning model such as a convolutional neural network (CNN) learned to classify the image of the actual item. In this case, the major categories may be determined by learning a first overall contour shape and a first typical (or alternatively, ‘representative’ or ‘example’ throughout the present disclosure) feature element of each item through the item. The first category may be set to be same as a type included in the menu 404 in FIG. 4 or may be composed of subclassified major categories as compared to the type 404. The first category may be stored in the memory 320 of the server 300 and/or a separate database.

Classification of the first category may be performed by comparing the feature representations of the target item 410 with the feature representations of an item belonging to each major category of the first category, and the target item 410 may be classified as a major category indicating a highest degree of matching with respect to at least one of the first overall contour shape or the first feature element.

FIG. 6 shows a men's coat as a wearable target item 410. The first category may include a men's coat, a women's coat, a women's blouse, a dress, pants, a skirt, a t-shirt, a knit, a jacket, a shirt and the like as clothes. The first category may be distinguished based on the first overall contour shape and the first typical category characterized in clothes. In the case of a men's coat, the first overall contour shape may include, for example, a line shape different from that of a women's coat and a pocket shape and arrangement different from that of a women's coat, and the first feature element may include, for example, unique design elements applied to the men's coat, such as a button shape and arrangement different from that of the women's coat and a collar different from that of the women's coat.

The first category of the present example may be classified as the men's coat by comparing the feature points of items belonging to the men's coat, the women's coat, the t-shirt, the knit, the jacket and the shirt, which are major categories related to a top, with the feature points of the target item.

In addition to the first category of the clothes, the first category may include accessories such as glasses, hairpins and necklaces as wearable items and belongings such as bags or umbrellas placed around the avatar.

Subsequently, the server 300 may classify the target item 410 as a second category which is a subcategory of the first category (S125).

The secondary category may be classified into the subcategories in the first category. The second category may be generated as subcategories for the actual item using a deep learning mode such as a CNN learned to subclassify the image of the actual item in the first category, as described above. The subcategories may be determined by learning a second overall contour shape and a second feature element of each item through the image. The second category may be stored in the memory 320 of the server 300 and/or a separate database.

Classification of the second category may be performed by comparing the feature representations of the target item 410 with the feature representations of an item belonging to each subcategory of the second category, and the target item 410 may be classified as a subcategory indicating a highest degree of matching with respect to at least one of the second overall contour shape or the second feature element.

FIG. 6 shows a trench coat of the men's coat as the wearable target item 410. The second category may include a double coat, a polo coat, a trench coat and a Chesterfield coat as the men's coat. The second category may be distinguished based on the second overall contour shape and the second typical category characterized in each men's coat. In the case of the trench coat, the second overall contour shape may be a unique shape of the trench coat different from that of the other men's coats, such as a unique line shape, pocket shape and sleeve shape of the trench coat. The second feature element may be a unique design element of the trench coat different from that of the other men's coats, such as unique button arrangement or collar's detailed shape of the trench coat.

The second category of the present example may be classified as the men's trench coat by comparing the feature representations of items belonging to the subcategory of the men's coat with the feature representations of the target item.

In addition to the second category of the clothes, the second category may include subcategories for each major category for classifying accessories and belongings.

Next, the server 300 may provide a template 412 of the target item 410 in association with the second category (S130). This is shown in the fourth figure of FIG. 6.

The template 412 may be a basic modeling for the subcategory of the second category. The template 412 may be basic modeling, to which the overall contour shape and feature element of each subcategory are applied, and the template 412 may include at least one basic modeling for each subcategory. In the case of a single template 412, the template 412 may be generated by a shape and element selected from the second overall contour shapes and the second feature elements of the subcategory. In the case of a plurality of templates 412, the overall contour shapes and the feature elements are variously combined. Therefore, the template 412 may include the same basic modeling as the target item 410 and, in some cases, the template 412 having a shape and element slightly different from those of the target item 410 may be provided.

Further, the template 412 may be provided to be the same as the image format of the avatar 402. The image format may mean an image generation type such as an image type (e.g., jpg, png, bmp, gif, etc.) of the avatar, a two-dimensional or three-dimensional format, a graphic/animation format.

In the case of a plurality of templates 412, a template 412 having a highest degree of similarity with at least one of the second overall contour shape or second feature element of the target item 410, which is extracted from the templates in the second category, may be provided. The degree of similarity may be obtained by comparing and analyzing the feature representations of the plurality of templates and the feature representations of the target item 410.

As shown in FIG. 6, when the image of the cut target item 410 is classified as a men's trench coat and a plurality of the templates 412 is provided, the template 412 may be selected as basic modeling indicating a highest degree of similarity with the line shape, pocket shape, sleeve shape and button arrangement, collar shape of the target item 410 and so on. The template 412 of FIG. 6 includes a waist belt that is not included in the target item 410, but many parts of the second overall contour shapes and the second feature elements of the template and the target item match each other, so that the template 412 shown in FIG. 6 may be selected.

Next, a style attribute may be extracted from the image of the target item 410 (S135).

The style attribute may be a design element related to a portion of the target item 410 in addition to the overall contour shape of the extracted target item 410. The design elements related to the portion may include a typical design element applied to a large portion of the target item 410, such as a color, pattern or texture of the target item 410 and an atypical design element applied to a local portion of the target item 410, such as a uniquely shaped pocket and button, a mark or partial decoration. The pattern of the typical design element may include a solid pattern, a check, a herringbone, a stripe, a camouflage in the case of the clothes.

According to the result of extraction of the style attribute, the atypical design element may be the same as the second feature element of the template 412, but because the second feature element has a basic shape, the typical design element may be extracted differently from the second feature element.

The style attributes may be all design elements from the image of the target item 410, but the style attributes may be partially extracted from the image in order to reduce a load of a device and exclude unnecessary or undesired design elements according to input image quality, a size of a particular atypical design element in the image and a size of a virtual item. Partial extraction may be performed based on at least one of an entire or partial shape of the avatar 402, an entire or partial shape of the template 412, or a characteristic degree of the style attribute in the image.

For convenience, partial extraction will be described with reference to FIG. 6. The style attribute extracted from the image of the target item 410 may include beige, a solid pattern, a heart-shaped mark (e.g., badge or Wappen), a belt-type sleeve, a diagonal pocket, etc. The virtual item of the first figure of FIG. 6 will be described, for example. The style attribute which is not extracted includes a diagonal partial cover located on the chest of the target item 410 (a partial cover shown on the left side of the target item 410 in the first figure of FIG. 6). This is determined as a smaller style attribute than the total size of the avatar 402 and/or the template 412 and thus the partial cover may be excluded. As another example, the partial cover may be excluded in consideration of the shape of the chest which is a portion of the avatar 402 and/or the template 412. As another example, an atypical design element of the style attribute of the target item 410 of FIG. 6 includes a heart-shaped mark, a belt-type sleeve, a diagonal pocket, a partial cover, etc. Considering a size ratio occupied in the target item 410 and a degree of importance of design learned in relation to the target item 410, it may be determined that the partial cover has a lower characteristic degree of the style attribute than the mark, the sleeve and the pocket. Therefore, the partial cover may be excluded from partial extraction.

Meanwhile, extraction of the style attribute may be performed through the server 300 or the avatar application of the user device 200. When this is performed in the user device 200, the template 412 may be transmitted to the user device 200 and used in a subsequent operation.

Next, a virtual item 416 is generated based on the template 412, to which the extracted style attribute is added (S140). A detailed process of generating the virtual item 416 will now be described.

The image of the style attribute extracted to be same as the image format of the avatar 402 may be converted into a virtual style image 414. The image format has substantially the same meaning as described in operation S130. The virtual style image 414 may be generated using an image processing method (e.g., a generative adversarial network (GAN) method). In the virtual style image 414 of the fifth figure of FIG. 6, some of the extracted style attribute are shown. In FIG. 6, for example, the virtual style image 414 may be converted to include beige, a solid pattern, a heart-shaped mark, a belt-type sleeve, a diagonal pocket, etc.

Subsequently, when the avatar 402 has a three-dimensional shape, the virtual style image 414 may be synthesized with the three-dimensional mesh of the template 412 to approach or approximate the arrangement of the style attribute of the target item 410. Based on the pixel position of the style attribute extracted from the target item 410 and the coordinates of the three-dimensional mesh of the template 412, the extracted style attributes may be synthesized to be located on the corresponding portion of the template 412.

Subsequently, the template 412 including the virtual style image 414 may be corrected or modified such that the template 412 in which the virtual style image 414 is synthesized is suitable for an avatar service. Such correction or modification may be realized by, for example, a cartoon shader such that the contrast of a three-dimensional object or the strength of a borderline is adjusted to be suitable for a graphic avatar 402. The cartoon shader will now be described in detail. Contrast may be simplified by strongly applying virtual light to the synthesized template 412, the template 412 may be processed to be more animated and a particular color is applied along the borderline (or outline) of the template 412. As another example, correction or modification may include fine adjustment of the size of the template 412 and the size, ratio and arrangement of the style attribute based on the skin color and body part size of the avatar 402.

In the above-described process, the virtual item 416 may be generated as shown in the last figure of FIG. 6. This may be performed through the server 300 or the avatar application of the user device 200.

Next, the virtual item 416 is applied to the avatar (S145). This may be performed by the server 300 or the user device 200.

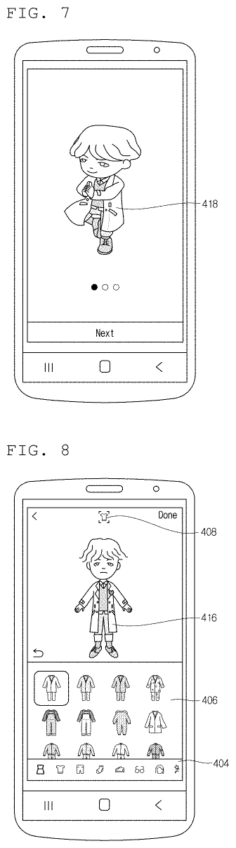

FIG. 7 is a view showing an example of presenting a virtual item according to an example embodiment of the present disclosure.

The user device 200 may display the avatar 418, to which the generated virtual item 416 is applied, through the output unit 250, and the user may confirm the avatar 418 including the virtual item 416 and approve the avatar through an approval button (“Next” in FIG. 7), as shown in FIG. 7.

FIG. 8 is a view illustrating an example of an avatar, to which a virtual item is finally applied, according to an example embodiment of the present disclosure. A final avatar is an avatar whose virtual item is fixed by the above-described approval.

The user device 200 may display a finally applied avatar on an initial screen as shown in FIG. 8, and the final avatar may be provided to an online service linked to the avatar application. In this case, the final avatar 418 may be selected from avatars of the user associated with the user device 200 or may be provided by default by an avatar service.

Further, according to the example embodiment of the present disclosure, when the virtual item 416 is newly generated, the new virtual item 416 may be included as an item corresponding to the existing higher type of the menu 404. As another example, according to the request of the user or the server, the new virtual item 416 may be incorporated as the item of the newly generated higher type. As another example, the higher type newly generated by the request of the user device 200 or the server 300 may not be displayed on the menu 404 of the user device 200 in which the new virtual item is generated, according to the personalization instruction of the user device 200.

According to the present example embodiment, because a virtual item applied to an avatar is automatically or easily generated from an item obtained from an image without operation of a service provider, it is possible to more emphasize the personality of the avatar and to secure various designs of the item for the avatar.

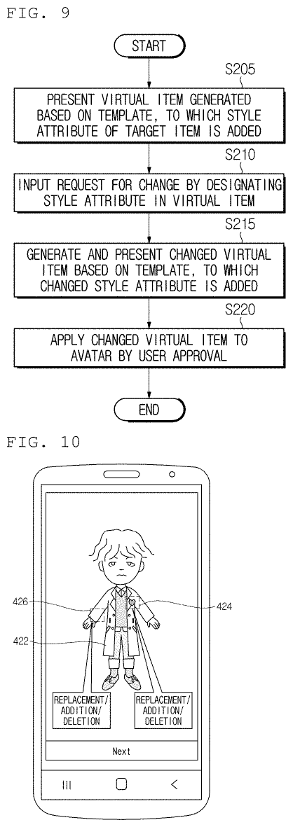

FIG. 9 is a flowchart illustrating a method of generating an item for an avatar according to another example embodiment of the present disclosure. Another example embodiment of the present disclosure shown in FIG. 9 relates to change of style attribute desired by a user after a virtual item is generated, and may start from operation S130 of FIG. 3. In the following description, the meaning, operation and function of the terms the same as or substantially similar to those of the method of generating the item for the avatar according to the example embodiment of the present disclosure described with reference to FIG. 3 will be omitted.

Referring to FIG. 9, the user device 200 may present a virtual item 422 generated based on the template 412, to which the style attribute of the target item 410 are added, through the output unit 250 (S205).

The style attributes may be all typical and atypical design elements from the image of the target item 410, and in some cases, may be partially extracted from the image. Partial extraction may be performed based on an entire or partial shape of the avatar 402, an entire or partial shape of the template 412 and a characteristic degree of the style attribute in the image. For example, partial extraction may mean extraction of some of the atypical design elements from the image of the target item 410.

FIG. 10 is a view illustrating an example of changing a style attribute in a virtual item according to another example embodiment of the present disclosure.

FIG. 10 shows a screen of the output unit 250 of the same operation as FIG. 7 and shows an example of the screen displayed on the user device 200 such that the avatar including the virtual item is confirmed and approved.

The style attributes of the image of the men's trench coat which is the target item 410 shown in FIG. 5 include beige, a solid pattern, a heart-shaped mark, a belt-type sleeve, a diagonal pocket, etc. However, from the virtual item 422 of FIG. 10, it can be seen that the virtual item 422 is generated without extracting the belt-type sleeve and the partial cover of the chest from among the style attributes of the target item 410.

Next, the user device 200 may receive user designation for the style attribute in the virtual item 422 and generate a user's request for change of the designated style attribute (S210).

Referring to FIG. 10 again, the user device 200 may activate a detection function for the entire region of the virtual item 422 displayed on the output unit 250 so as to recognize user touch input and/or pointing device designation. The user device 200 may set the inside of the outermost contour of the virtual item as a detection region.

The user may designate particular regions 424 and 426 indicated by dotted lines of FIG. 10 related to the style attributes to be changed by touch input and/or a pointing device. When the particular regions 424 and 426 are small, the user device 200 may enlarge the screen of the virtual item 422 according to a user's screen enlargement instruction, thereby providing convenience to user designation for the style attribute having a small size and improving recognition accuracy of the designated style attribute. As another example, for convenience and accuracy, the user device 200 may reduce a screen according to a user's screen reduction instruction to help the user to designate a style attribute having a large size. Although, in the above description, user designation is described as being performed by touch input for the regions 424 and 426 of the corresponding style attribute, the user device 200 may estimate the designated style attribute by recognizing a user gesture of surrounding the corresponding region. The present disclosure is not limited thereto and the user device 200 may include various types of user designation.

The user device 200 may display a change menu after the user detects particular style attribute designation. For example, the change menu according to the style attribute may be displayed by grasping the data of the designated style attribute, as shown in FIG. 10.

For example, referring to FIG. 10, when the user designates the region 424 for the style attribute of the heart-shaped mark, the user device 200 may present a change menu having replacement/addition/deletion as items capable of being changed in relation to the heart-shaped mark (e.g., change options associate with the heart-shaped mark).

Replacement may be a function for presenting candidate style attributes different from the heart-shaped mark and related to a mark previously generated in the avatar application and changing to a mark-related candidate style attribute selected by the user. As another example, when the user device 200 receives a replacement instruction for the region 426 for the typical design element such as a color or a pattern, although not shown, a query window for requesting selection of any one of the color, the pattern or the atypical design element may be displayed on the user device 200. Therefore, the user device 200 may display a detailed list related to the selected style attribute and generate a change request according to an instruction for replacement with a detailed style attribute selected from the detailed list. For example, when the user selects a color in the query window, the user device 200 may display various colors other than the current beige in the detailed list and generate a change request according to an instruction for replacement with a color selected by the user. As another example, the change request may be generated by receiving the replacement instruction of the typical design element such as a color and a pattern through another button (not shown) provided on the screen differently from FIG. 10. As another example, when the user selects an atypical design element in the query window, the user device 200 may receive the replacement instruction according to the detailed design of the atypical design element selected by the user, by sequentially displaying a list of atypical design elements and query windows including a sub-list.

Addition may refer to the addition of a style attribute that is not present in the virtual item 422 but is included in the image of the target item 410. Referring to FIG. 10, when the user device 200 receives “addition” as the input of the change menu with regard to the region 426 of the solid pattern, the image of the target item 410 may be displayed through the output unit 250.

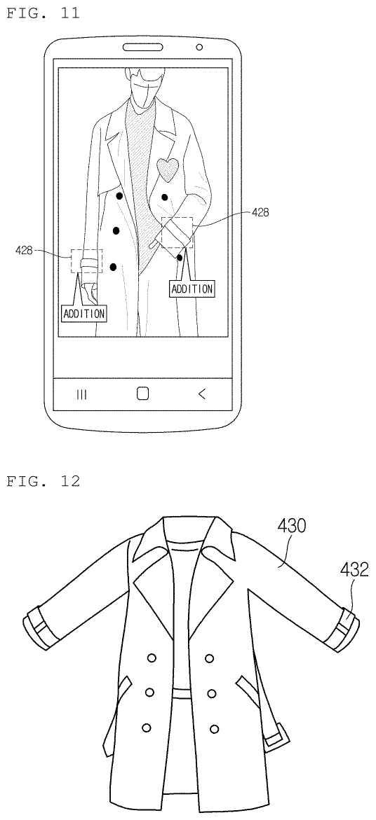

FIG. 11 is a view illustrating an example of additionally changing a style attribute of an image of an item according to another example embodiment of the present disclosure.

The target item 410 is displayed as shown in FIG. 11, and the user device 200 may display the image of the sleeves corresponding to the ends of the arms designated in the virtual item. Further, the user device 200 may display regions 428 corresponding to the sleeves in the image for user convenience, and may receive an instruction for addition to the sleeves in the regions 428 to generate a change request, for accurate recognition of the added style attribute.

For example, referring to FIG. 10, deletion is selected with respect to the heart-shaped mark related to the region 424, and the user device 200 may receive an instruction for deleting the heart-shaped mark to generate a change request.

The change menu shown in FIG. 10 includes all three items or options (e.g., replacement, addition and deletion), but the user device 200 may display some of the items by comparing the images of the current virtual item 422 and the target item 410. For example, the change menu including replacement and addition may be present, for the region 426 indicating the sleeve having the solid pattern of FIG. 10.

Referring to FIG. 9 again, a changed virtual item 430 may be generated and presented based on the template, to which the style attribute changed according to the change request is added (S215).

The changed virtual item 430 is generated by conversion into the virtual style image having the changed style attribute, synthesis with the template and correction/modification, and this is the same as or substantially similar to operation S130 of FIG. 3. However, when the style attribute is added to the image of the target item 410, the style attribute may be extracted from the target item 410 and then converted into the virtual style image. Extraction of the style attribute is the same as or substantially similar to operation S125 of FIG. 3.

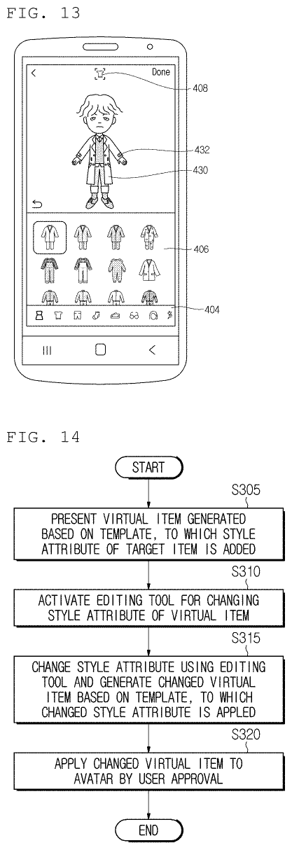

FIG. 12 is a view illustrating an example of a generated virtual item according to another example embodiment of the present disclosure.

According to the change request related to deletion of the heart-shaped mark and addition of the sleeve, it can be seen that the heart-shaped mark is deleted from the changed virtual item 430 shown in FIG. 12 and the sleeve similar to that of the image of the target item 410 is added as the sleeve 432.

Subsequently, the user device 200 may apply the changed virtual item to the avatar by user approval (S220).

As shown in FIG. 10, the user device 200 may display the avatar 402, to which the generated changed virtual item 430 is applied, through the output unit 250, and the user may confirm and approve the avatar 402 including the virtual item 430. The approved changed virtual item 430 is applicable to the avatar. FIG. 13 is a view illustrating an example of an avatar, to which a changed virtual item is finally applied, according to another example embodiment of the present disclosure. The user may use the avatar, to which the changed virtual item 430 including the sleeve 432 is applied.

In another example embodiment of the present disclosure, operations S205, S210 and S220 may be performed by the user device 200 and/or the server 300, and operation S215 may be performed by the server 300 such that the changed virtual item is transmitted to the user device 200.

According to the present example embodiment, because the user may add a design element excluded upon extracting the style attribute, it is possible to generate the item closer to the target item 410. Further, because the style attribute may be freely replaced and deleted in the virtual item, it is possible to generate the item for the avatar desired by the user.

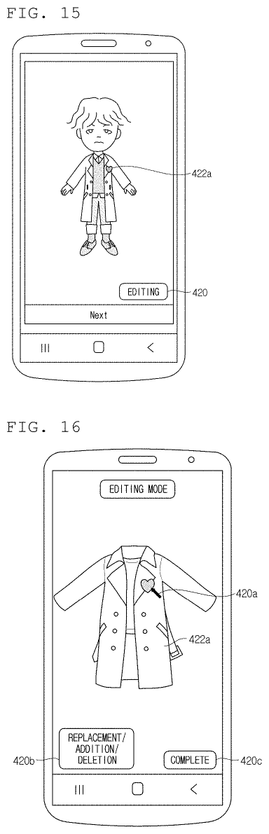

FIG. 14 is a flowchart illustrating a method of generating an item for an avatar according to another example embodiment of the present disclosure. The example embodiment of the present disclosure shown in FIG. 14 relates to change of the style attribute using a editing tool after generating a virtual item and may start from operation S130 of FIG. 3. In the following description, the meaning, operation and function of the terms the same as or substantially similar to those of the method of generating the item for the avatar according to the example embodiment of the present disclosure described with reference to FIG. 3 will be omitted. In FIGS. 15 to 17 illustrating the process of FIG. 14, the server 300 provides the user device 200 with an editing tool built in an avatar application.

Referring to FIG. 14, the user device 200 may present the virtual item 422 generated based on the template 412, to which the style attribute of the target item 410 is added, through the output unit 250 (S305).

FIGS. 15 to 17 are views illustrating an example of changing a style attribute in a virtual item using an editing tool according to an example embodiment of the present disclosure.

FIG. 15 shows the screen of the output unit 250 in the same operation as FIG. 7 and shows an example of the screen displaying a softkey such as “editing” 420 for activating an editing tool for changing the style attribute along with “Next” in the user device 200, such that the avatar including the virtual item 422 is confirmed and approved.

The style attributes of the image of the men's trench coat, which is the target item 410 shown in FIG. 5 include beige, a solid pattern, a heart-shaped mark, a belt-type sleeve, a diagonal pocket, etc. However, from the virtual item 422a of FIG. 15, it can be seen that the virtual item 422a is generated without extracting the partial cover of the chest and the belt-type attribute from among the style attributes of the target item 410.

Next, the user device 200 may activate the editing tool by receiving a request of the editing tool for changing the style attribute of the virtual item 422a (S310).

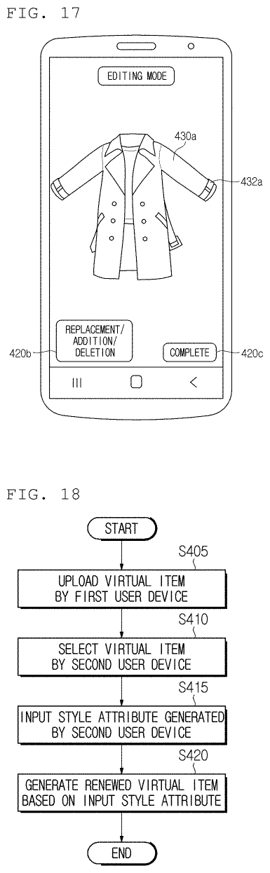

Referring to FIGS. 15 and 16, the user device 200 may activate the editing tool by providing the screen of the editing tool by user's selection for the editing 420.

As shown in FIG. 16, the editing tool may include an editing pointer 420a, a change selection key 420b and a completion key 420c, as elements for changing the style attribute of the virtual item 422a. The editing pointer 420a may be a tool moving on the screen by user touch input and/or a pointing device. The user may designate a particular region in the virtual item 422a using the editing pointer 420a to perform the change process of the style attributes, and select a desired changing process of the change selection key 420b. The change selection key 420b may include, for example, addition, deletion and replacement. Addition may be a function for adding a style attribute sketched by the user through the editing pointer 420a to a particular region of the virtual item 422a. Deletion may be a function for deleting a particular style attribute of the virtual item 422a selected by the editing pointer 420a. Replacement may be a function for replacing a particular style attribute selected by the editing pointer 420a with another style attribute such as a color, a pattern or a candidate attribute provided by the application.

The completion key 420c may be a soft key selected by the user when change of the style attribute performed by the user is completed.

Next, the user device 200 may change the style attribute of the virtual item 422a based on user's manipulation input using the editing tool, and generate the changed virtual item based on the template, to which the changed style attribute is added (S315).

For example, deletion of the heart-shaped mark (see FIG. 16) and addition of the sleeve 432a in the virtual item 422a shown in FIG. 17 will be described.

When the style attribute of the heart-shaped mark is selected by the editing pointer 420a and deletion is detected in the change selection key 420b, the user device 200 deletes the heart-shaped mark. Further, the user selects addition in the change selection key 420b through the editing pointer 420a to sketch and add the sleeves 432a having a desired shape to the both ends of the arms of the virtual item 422a. Sketching is possible even in the virtual item 422a initially presented on the screen, and the ends of the arms of the virtual item 422a may be enlarged or a separate window may be provided for convenience of editing.

The user device 200 receives the change request such as addition or deletion of the style attribute and generates the changed virtual item 430a based on the template, to which the changed style attribute is added. Generation of the changed virtual item 430a may include converting the style attribute freely sketched and added by the user into the virtual style image, synthesizing the converted virtual style image with the template, and performing correction/modification such as cartoon shader.

Next, the user device 200 may apply the changed virtual item 430a to the avatar by user approval (S320).

For example, as shown in FIG. 17, when the user completes change of the style attribute, the completion key 420c may be selected and the user device 200 may receive completion and regard the changed virtual item as being approved by the user. At this same time, the user device 200 may finish the editing tool and return to the screen shown in FIG. 15 to present the avatar, to which the changed virtual item 430a is applied.

FIGS. 15 to 17 show the server 300 providing the editing tool built in the avatar application to the user device 200. In another example embodiment of the above-described example, the user device 200 may be set to be connected to a drawing tool (e.g., a drawing board) embedded in the device through the screen shown in FIG. 15 or another key. Therefore, the user may freely change the style attribute through the function for adding or deleting the style attribute through sketch input provided by the embedded drawing tool. The virtual item changed by the embedded drawing tool may be converted by a desired (or alternatively, predetermined) processing or conversion process upon being input through the avatar application.

Meanwhile, the example embodiments shown in FIGS. 9 to 13 may be combined with the example embodiments shown in FIGS. 14 to 17.

According to the present example embodiment, the user may freely generate a style attribute which is not present in the candidate style attributes provided by the avatar application or the target item and add the style attribute to the virtual item.

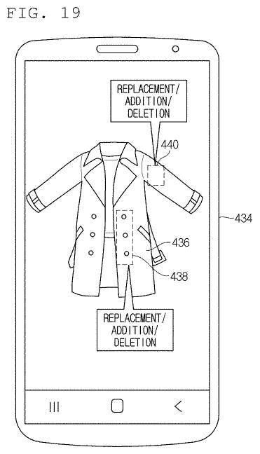

FIG. 18 is a flowchart illustrating a method of generating an item for an avatar according to another example embodiment of the present disclosure. The example embodiment of the present disclosure shown in FIG. 18 relates to the case where when a virtual item is generated by a first user device and is shared with another user, and a second user device shares and generates the virtual item. In the following description, the meaning, operation and function of the terms the same as or substantially similar to those of the method of generating the item for the avatar according to the example embodiments of the present disclosure described with reference to FIGS. 3 and 9 will be omitted.

First, the first user device may upload a virtual item 434 generated according to an example embodiment of the present disclosure (S405).

The first user device may upload the virtual item 434 in a desired (or alternatively, predetermined) sharing space according to the sharing approval of the first user. The desired (or alternatively, predetermined) sharing space may be provided in the avatar application and/or the online service liked thereto.

Subsequently, the second user device may receive a virtual item 436 from the sharing space including a plurality of shared virtual items by selection of the second user (S410). According to an example, only when the first user and the second user have a certain relationship in a social network, the virtual item 434 uploaded by the first user may be searched for in the sharing space including the plurality of virtual items. According to another example, only when a purchase transaction occurs by the second user, the virtual item 436 may be received.

Next, the second user device may receive input of the second user for requesting change to a style attribute different from that of the virtual item 436 (S415). According to an example, in operation S405, the first user may input whether or not to allow attribute change of the virtual item 436, and only when attribute change is allowed, the second user device may receive input of the second user for requesting change to the style attribute different from that of the virtual item 436.

FIG. 19 is a view illustrating an example of inputting a style attribute from a second user device for a shared virtual item according to another example embodiment of the present disclosure.

The second user device 434 may activate the detection function for the entire region of the displayed virtual item 436, equal or substantially similar to operation S210 of FIG. 9.

The second user may designate particular regions 438 and 440 indicated by dotted lines of FIG. 19 related to the style attributes to be changed through touch input and/or a pointing device. As in operation S210, the second user device 434 may enlarge or reduce the screen of the virtual item 436 according to the screen enlargement or reduction instruction of the user, thereby providing convenience to user designation of the style attribute. As another example, the second user device 434 may estimate a style attribute designated by recognizing a user's gesture of surrounding a corresponding region. Further, the user device 200 may include various types of user designation.

The user device 200 may display a change menu after the user detects particular style attribute designation. For example, the change menu according to the style attribute may be displayed by grasping the data of the designated style attribute, as shown in FIG. 19.

For example, as shown in FIG. 19, when the user designates a region 438 for the style attribute of the button, the user device 200 may present a change menu having replacement, addition and deletion as an item changeable in relation to the button.

Deletion may be the same as or substantially similar to operation S210. Addition may include presenting candidate style attributes of various categories previously produced by the avatar application and adding a candidate style attribute selected by the second user to a particular region 440. Replacement may include presenting candidate style attributes related to the button, which are previously generated by the avatar application. As another example of replacement, the second user device 434 may generate a replacement instruction based on the style attribute generated by the second user in the same image format as the virtual item 436. The style attribute in the same image format may be a style attribute related to the virtual item generated by performing the process of FIG. 3 and/or FIG. 9 with respect to the target item obtained by the second user device 434 as an image. Of course, the avatar application may provide the editing tool shown in FIGS. 14 to 17 capable of generating a separate style attribute in the same image format and thus the second user device 434 may generate a replacement or addition instruction based on the style attribute generated by the editing tool. Further, input of the second user related to replacement of the color, the pattern, the texture and the atypical design element is the same as or substantially similar to the replacement instruction in operation S210 and thus will be omitted.

Next, the second user device 434 may generate a renewed virtual item based on the received style attribute (S420).

Change of the shared virtual item 436 may be performed in the image format of the virtual item of the first user. Further, the renewed virtual item may be re-shared or privately owned according to the request of the second user.

Although the style of the shared virtual item is described as being changed by detecting designation of the shared virtual item in the present example embodiment, a plurality of style change related menus may be disposed in a separate region from the virtual item on the screen and the second user may change the style attribute through the menus. The present disclosure is not limited thereto and change of the shared virtual item may be implemented through various types of interfaces.

According to the present disclosure, it is possible to provide a method of generating an item for an avatar, which is capable of automatically or easily generating a virtual item to be applied to the avatar from an item obtained from an image.

According to the present disclosure, it is possible to provide a computing device for implementing methods of generating an item for an avatar.

According to the present disclosure, it is possible to provide a computer-readable recording medium having recorded thereon a program that when executed by at least one processer, cause a computing device to execute methods of generating an item for an avatar on a computing device.

According to the present disclosure, an item for an avatar may be easily created taking advantage of an image, which is readily available. Thus, the item for the avatar may be created in less time and/or consuming less computing resources.

It will be appreciated by persons skilled in the art that that the effects that can be achieved through the present disclosure are not limited to what has been particularly described hereinabove and other advantages of the present disclosure will be more clearly understood from the detailed description.

Effects obtained in the present disclosure are not limited to the above-mentioned effects, and other effects not mentioned above may be clearly understood by those skilled in the art from the above description.

While some example methods of the present disclosure described above are represented as a series of operations for clarity of description, it is not intended to limit the order in which the operations are performed, and the operations may be performed simultaneously or in different order as desired. In order to implement some example methods according to the present disclosure, the described operations may further include other operations, may include remaining operations except for some of the operations, or may include other additional operations except for some of the operations.

The various example embodiments of the present disclosure are not a list of all possible combinations and are intended to describe representative aspects of some example embodiments of the present disclosure, and the matters described in the various example embodiments may be applied independently or in combination of two or more.

A method for method of generating item for avatar according to the present disclosure may be implemented with program instructions that can be executed by various computing devices and which can be recorded in a computer-readable recording medium. The computer-readable recording medium may store program instructions, data files, data structures, and the like solely or in combination. The program instructions recorded on the medium may be ones that are specifically designed and configured to carry out the present invention or may be publicly available to professionals in the field of computer software. Examples of the computer-readable recording medium include magnetic media such as hard disks, floppy disks, and magnetic tapes, optical media such as CD-ROMs and DVDs, magneto-optical media such as floptical disks, and hardware devices, specifically configured to store and execute program instructions, such as ROM, RAM, and flash memory. Examples of the program instruction include machine language codes generated by a compiler and high-level language codes that are generated by an interpreter and which can be executed by a computer. The hardware device described above may be configured as at least one software modules to perform the method of the present invention, and vice versa.

Further, various example embodiments of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various example embodiments to be executed on an apparatus or a computer, and a non-transitory computer-readable medium having such software or commands stored thereon and executable on the apparatus or the computer.

According to methods of some example embodiments, some operations (or steps) may be excluded from among the disclosed operations (or steps), or some additional operations (or steps) may be additionally included.

What is claimed is:

1. A method of generating an item for an avatar performed by a computing device including at least one processor, the method comprising:
extracting, by the computer device, a target item selected by a user device from an image;
classifying, by the computer device, the extracted target item into a category;
providing, by the computer device, a template of the target item in association with the category;
obtaining, by the computer device, a style attribute of the extracted target item from the image; and
generating, by the computer device, a virtual item to be applied to the avatar based on a modified template, the modified template created by adding the obtained style attribute to the template.

2. The method of claim 1,
wherein the classifying comprises:
classifying the target item into a first category; and
classifying the target item into a secondary category, the second category being a subcategory of the first category, and
wherein the providing comprises providing a specific template associated with the second category as the template of the target item.

3. The method of claim 1, wherein the providing comprises providing, as the template of the target item, a specific template having a highest degree of similarity with at least one of an overall contour shape and a feature element of the extracted target item among templates in the category.

4. The method of claim 1, wherein the style attribute is a design element related to a portion of the target item in addition to an overall contour shape of the extracted target item.

5. The method of claim 1, wherein the obtaining comprises obtaining the style attribute from the image based on at least one of an entire or partial shape of the avatar, an entire or partial shape of the template, or a characteristic degree of the style attribute in the image.

6. The method of claim 1, wherein the generating comprises:
converting an image of the obtained style attribute into a virtual style image to have a same format as an image format of the avatar;
synthesizing the virtual style image with a three-dimensional mesh of the template to approximate arrangement of the style attribute of the image;
modifying the template in which the virtual style image is synthesized; and
providing the modified template to the avatar.

7. The method of claim 1, further comprising:
generating, by the computer device, a change request for the style attribute in the virtual item in the user device; and
generating, by the computer device, a changed virtual item based on a changed template, the changed template being the template of the target item in which the style attribute has been changed according to the change request.

8. The method of claim 7, wherein the generating the change request comprises:
in case of deleting the style attribute from the virtual item, detecting a first designation of the style attribute of a deletion region, receiving a deletion instruction among presented options of a change menu and generating the change request;
in case of adding an additional style attribute which is not present in the virtual item, detecting a second designation of a specific portion of the virtual item of an addition region, receiving an addition instruction among the presented options of the change menu, presenting a target item image including the target item according to the addition instruction, receiving a request for adding the additional style attribute in the image corresponding to the designated specific portion of the virtual item, and generating the change request; and
in case of replacing the style attribute in the virtual item with a selected candidate style attribute, detecting a third designation of the style attribute of a replacement region, receiving a replacement instruction among the presented options of the change menu, presenting candidate style attributes different from the style attribute to be replaced, receiving a replacement request according to the selected candidate style attribute and generating the change request.

9. The method of claim 7, wherein the generating the change request comprises:
activating an editing tool for changing the style attribute; and
generating the change request including at least one of addition, deletion, or replacement of the style attribute with respect to at least a portion of the virtual item, based on manipulation of the editing tool from the user device.

10. The method of claim 1, further comprising:
uploading the virtual item by the user device;
receiving selection of the virtual item from another user device;
receiving an input of another style attribute from the another user device, the another style attribute being different from that of the virtual item; and
generating a renewed virtual item based on the received style attribute.

11. A computer-readable recording medium having recorded thereon a program that, when executed by at least one processor, causes a computing device to execute a method of generating an item for an avatar, the method comprising:
extracting a target item selected by a user device from an image;
classifying the extracted target item into a category;
providing a template of the target item in association with the category;
obtaining a style attribute of the extracted target item from the image; and
generating a virtual item to be applied to the avatar based on a modified template, the modified template created by adding the obtained style attribute to the template.

12. A computing device comprising:
at least one processor configured to execute computer-readable instructions included in a memory such that the processor is configured to cause the computing device to,
extract a target item selected by a user device from an image,
classify the extracted target item into a category,
provide a template of the target item in association with the category,
obtain a style attribute of the extracted target item from the image, and
generate a virtual item to be applied to an avatar based on a modified template, the modified template created by adding the obtained style attribute to the template.

13. The computing device of claim 12,
wherein the processor is configured to cause the computing device to classify the extracted target item by,
classifying the target item into a first category, and
classifying the target item into a secondary category, the second category being a subcategory of the first category, and
wherein the processor is configured to cause the computing device to provide a specific template associated with the second category as the template of the target item.

14. The computing device of claim 12, wherein the processor is configured to cause the computing device to provide, as the template of the target item, a template having a highest degree of similarity with at least one of an overall contour shape and a feature element of the extracted target item among templates in the category.

15. The computing device of claim 12, wherein the style attribute is a design element related to a portion of the target item in addition to an overall contour shape of the extracted target item.

16. The computing device of claim 12, wherein the processor is configured to cause the computing device to obtain the style attribute from the image by obtaining the style attribute from the image based on at least one of an entire or partial shape of the avatar, an entire or partial shape of the template or a characteristic degree of the style attribute in the image.

17. The computing device of claim 12, wherein the processor is configured to cause the computing device to generate the virtual item by:
converting an image of the obtained style attribute into a virtual style image to have a same format as an image format of the avatar;
synthesizing the virtual style image with a three-dimensional mesh of the template to approximate arrangement of the style attribute of the image;
modifying the template in which the virtual style image is synthesized; and
providing the modified template to the avatar.

18. The computing device of claim 12, wherein the processor is further configured to cause the computing device to:
generate a change request for the style attribute in the virtual item in the user device; and
generate a changed virtual item based on a changed template, the changed template being the template of the target item in which the style attribute has been changed according to the change request.

19. The computing device of claim 18, wherein the processor is configured to cause the computing device to generate the change request by:
in case of deleting the style attribute from the virtual item, detecting a first designation of the style attribute of a deletion region, receiving a deletion instruction among presented options of a change menu and generating the change request;
in case of adding an additional style attribute which is not present in the virtual item, detecting a second designation of a specific portion of the virtual item of an addition region, receiving an addition instruction among the presented options of the change menu, presenting a target item image including the target item according to the addition instruction, receiving a request for adding the additional style attribute in the image corresponding to the designated specific portion of the virtual item, and generating the change request; and
in case of replacing the style attribute in the virtual item with a selected candidate style attribute, detecting a third designation of the style attribute of a replacement region, receiving a replacement instruction among the presented options of the change menu, presenting candidate style attributes different from the style attribute to be replaced, receiving a replacement request according to the selected candidate style attribute and generating the change request.

20. The computing device of claim 18, wherein the processor is configured to cause the computing device to generate the change request by:
activating an editing tool for changing the style attribute; and
generating the change request including at least one of addition, deletion or replacement of the style attribute with respect to at least a portion of the virtual item, based on manipulation of the editing tool from the user device.
